(19) United States
(12) Patent Application Publication
(10) Pub. No.: US 2006/0123021 A1
(43) Pub. Date: Jun. 8, 2006

(54) Hierarchical packaging for telecommunications and computing platforms

(76) Inventor: Charles Calvin Byers, Wheaton, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/005,068

(22) Filed: Dec. 6, 2004

(51) Int. Cl. G06F 17/30

(52) U.S. Cl. 707/100

(57) ABSTRACT

The present invention provides a hierarchical packaging of electronic equipment that includes a first order assembly and a second order assembly. The first order assembly includes a plurality of modules and a means of mechanically supporting, interconnecting, powering, cooling and managing said modules. The second order assembly includes a plurality of the first order assemblies, and a means of mechanically supporting, interconnecting, powering, cooling and managing said first order assemblies.

### FIELD OF THE INVENTION

The present invention relates generally to the packaging of electronic systems, and more specifically to a hierarchical packaging arrangement of universal platform elements for telecommunications and data networking systems.

### BACKGROUND OF THE INVENTION

Systems for telecommunications or data network elements are typically packaged using a non-related collection of cabinets, shelves, circuit boards, and mezzanine boards. Different combinations of specific building blocks at all of these levels can be configured together to provide specific system functionality. If a set of said building blocks are carefully created to permit their use in multiple different applications, a platform development approach exists.

Platforms can be either proprietary or based upon open standards. There is a recent trend among the manufacturers of telecommunications and data networking equipment to move away from proprietary platforms and toward platforms based upon open industry standards. Two of the most important of these open standards are the Advanced Telecommunications Computing Architecture (Advanced TCA, also known as PICMG3) for shelves and boards, and The Advanced Mezzanine Card (also known by its PICMG designation of AMC) for mezzanines, also known as daughter boards.

Advanced TCA and AMC are ideal for large scale, high capacity network elements. However, for smaller scale elements, or network elements with a very sensitive cost structure, Advanced TCA often can't be economically scaled low enough. AMC can be scaled to enable the creation of low cost systems, but no open industry standard exists to enable its marketplace. Also, typical packaging of AMCs can either permit the creation of inexpensive, but modest sized systems, or moderate sized systems with a cost structure that is too high.

A need therefore exists for an open industry standard, which permits the creation of both low cost and moderate scaling in the same basic packaging technique.

### BRIEF SUMMARY OF THE INVENTION

The present invention provides an improved method for packaging electronic components utilizing hierarchical packaging for telecommunications and computing platforms. In hierarchical packaging, a collection of standard mezzanine cards is equipped together into an assembly called a cube. A cube comprises a number of mezzanine boards plugged directly into a backplane, and the necessary mechanical elements, switching fabric, power, cooling and system management functions needed to operate them.

In a preferred embodiment, the cube comprises a packaged assembly of about sixteen AMCs, and the common elements needed to drive them. Groups of two or four mezzanine positions can be merged to provide bigger board area. In an exemplary embodiment, the cube fits inside a cube approximately 200 mm on a side. Small scale or cost sensitive systems can often be implemented in a single cube.

If scalability is needed beyond the relatively small number of mezzanine boards provided in a cube, a number of cubes can be interconnected through the use of an additional level of mechanical packaging, interconnect, cooling, power distribution and management infrastructure. In an exemplary embodiment, eight cubes are interconnected and controlled through a central resource called a superfabric. The superfabric has a mechanical footprint similar to the standard cube, permitting the creation of a three by three array of cube-sized packages that occupy space in a rack similar to an Advanced TCA shelf. One of these cubes includes central resources and is called the central fabric cube. The three by three array of cubes is ideal for intermediate sized systems.

If further scalability is needed, eight three by three cube arrays can be configured to fill three standard cabinets, along with a ninth super-super fabric shelf interconnecting the arrays and providing their shared mechanical, interconnect, cooling, power and management functions. In the preferred embodiment, the super-super fabric is an Advanced TCA shelf. Packaging of several cabinets into a single large sized system is ideal for the creation of the largest types of network elements.

This hierarchy can be extended more levels, until an entire network of packaged elements is created, comprising many buildings full of equipment, and potentially serving the full service communications and data processing needs of many thousands of subscribers.

Advantageously the same basic mechanical building block of the cube is used for implementing the small, intermediate, large, and network scale systems. This greatly improves the cost of systems, through reduced development and operational expense, and via the economies of scale of such a large number of identical cubes being produced. The vast majority of complexity and expense of systems are embodied in their constituent cubes, and only a small fraction are accounted for in the shared mechanical components or higher order fabrics.

The hierarchical packaging of the present invention also permits the natural use of hierarchical packet-based interconnect networks to connect all of the AMCs, cube fabrics and higher order fabrics. In an exemplary embodiment, the network is an Ethernet network, with a plurality of Gigabit Ethernet links connecting the AMCs in each cube to its fabric, and ten gigabit Ethernet links interconnecting the cube fabrics with the Superfabrics. The hierarchy may also be a hierarchy of serial RapidIO, PCI Express or InfiniBand links interconnects the AMCs, cube fabrics and superfabrics.

The present invention also provides an additional advantage, which is hierarchical management. In an exemplary embodiment, AMCs are managed using the IPMI protocol. The same protocol is extended in a hierarchical fashion to a central cube control entity, then to a superfabric control entity, and so on. This provides a unified, intuitive, and simple to use mechanism to manage large numbers of mezzanine boards, in a well-disciplined hierarchy. Simplifying management is an important way to minimize ongoing operational expense of a network.

Further, the present invention provides ease of system growth and scalability. Systems can start small, with only a single cube performing all of their functions. As their traffic grows, the systems can continue to use their original cubes, and add an inexpensive superfabric and shelf level packaging, and grow as many additional cubes as required. If the system outgrows the capabilities of the number of cubes supported on the shelf sized superfabric, a multi-shelf or multi-cabinet system, with a super-super fabric serving as a high-level interconnect can be utilized as the next growth step. Equipment is reused, and the incremental growth costs of upgrading to the next step in the hierarchy are a fraction of the cost of alternative non-hierarchical packaging concepts.

### BRIEF DESCRIPTION OF THE SEVERAL VIEWS OF THE DRAWINGS

FIG. 1 depicts a platform-based network in accordance with an exemplary embodiment of the present invention.

FIG. 2 depicts a block diagram of a cube in accordance with an exemplary embodiment of the present invention.

FIG. 3 depicts a mechanical design of a cube in accordance with an exemplary embodiment of the present invention.

FIG. 4 depicts a shelf level system comprising a plurality of cubes and a central SuperFabric cube to interconnect them together in accordance with an exemplary embodiment of the present invention.

FIG. 5 depicts the mechanical design of a shelf level system in accordance with an exemplary embodiment of the present invention.

FIG. 6 depicts a block diagram of a multi-shelf system in accordance with an exemplary embodiment of the present invention.

FIG. 7 depicts a mechanical view of a multi-shelf system in accordance with an exemplary embodiment of the present invention.

### DETAILED DESCRIPTION OF THE INVENTION

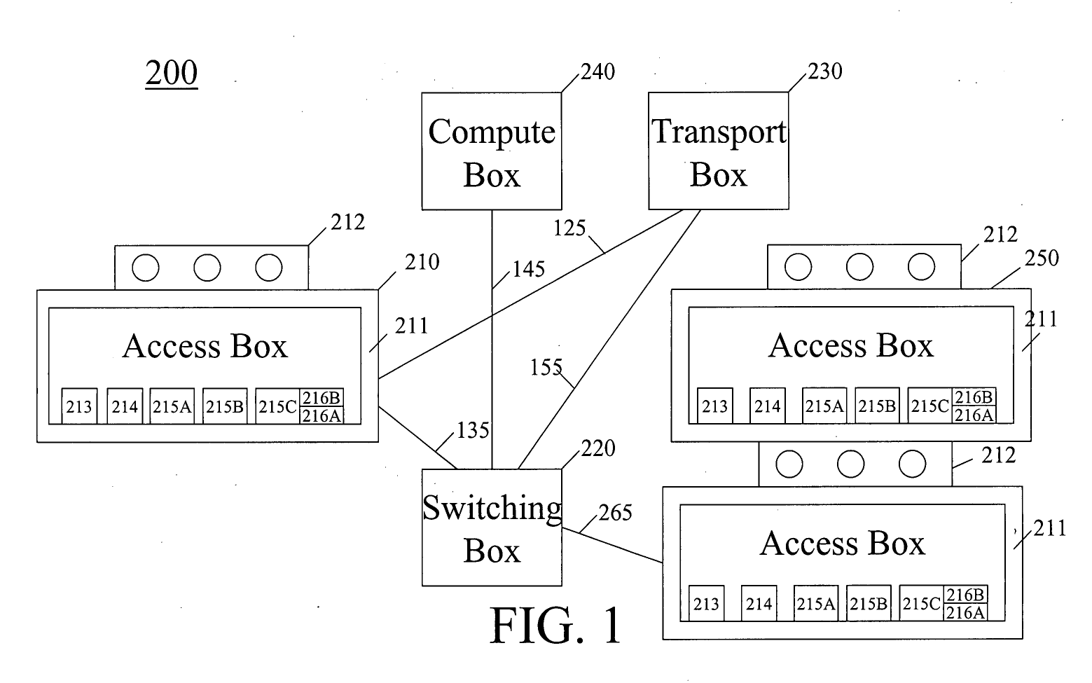

The present invention can be better understood with reference to FIGS. 1 through 7. FIG. 1 depicts a platform-based network 200 in accordance with the present invention. Platform-based network 200 comprises access box 210, switching box 220, transport box 230, computation box 240, and large scale access box 250 all linked together with links 125, 135, 145, and 155. However, in the hierarchical approach embodied in network 200, all of the network elements 210, 220, 230, 240, 250 are implemented using the same platform-based hierarchical system packaging.

Access box 210 comprises mechanical elements 211, cooling elements 212, power elements 213, common electronic and management functions 214, and a plurality of linecards 215a, 215b, and 215c. An exemplary linecard 215C further includes mezzanine cards 216A, and 216B. Advantageously, platform-based network 200 utilizes hierarchical packaging by using the same building blocks, 211, 212, 213, and 214 that were used in element 210, and only the linecards are specific to the functions of a particular box. This greatly reduces the cost of implementing hierarchical platform-based network 200.

Further, platform-based network 200 includes elements of different scales. For example, transport box 240 may require comparatively few modules, while large scale access box 250 may require many more modules. Larger scale elements like 250 are implemented with a plurality of identical central resources, all interconnected using a superfabric. The central resources needed to implement access box 250 are multiple identical copies of the same elements used to implement computation box 240, and the other elements in platform-based network 200. This reuse saves substantial development and deployment expense.

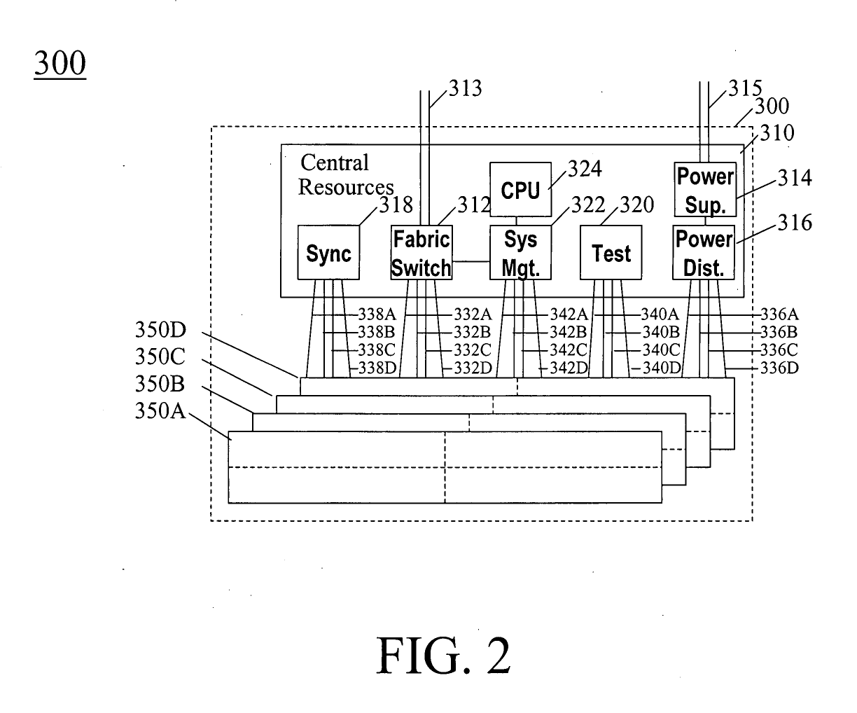

FIG. 2 shows a block diagram of a cube 300 in accordance with an exemplary embodiment of the present invention. Cube 300 is a self-contained electronic assembly that is capable of stand-alone operation or can be integrated along with other cubes and higher order fabrics into a complex system.

Cube 300 comprises at least one set of central resources 310. Central resources 310 comprises an interconnect fabric switch 312, power conditioning circuit 314, power distribution circuit 316, synchronization circuit 318, test circuit 320, management circuit 322, and cube control processor 324.

In an exemplary embodiment, a cube includes a single central resource. In a further exemplary embodiment, a cube includes a plurality of central resources, the number depending upon the level of fault tolerance required by a particular application.

Central resources 310 preferably includes a plurality of modules 350A-350D. Modules 350A-350D preferably include processing functions, packet interfaces, signal processors, storage, or various types of I/O interfaces. In the preferred embodiment, modules 350A-350D are AMC modules conforming to the PICMG standard.

Central resources 310 are preferably interconnected with modules 350A-350D over a variety of links, including main fabric interconnection links 332A-332D, power distribution links 336A-336D, synchronization links 338A-338D, test links 340A-340D, and management links 342A-342D.

Uplinks 313 and power connections 315 interconnect the resources of cube 300 with higher order functions of the system.

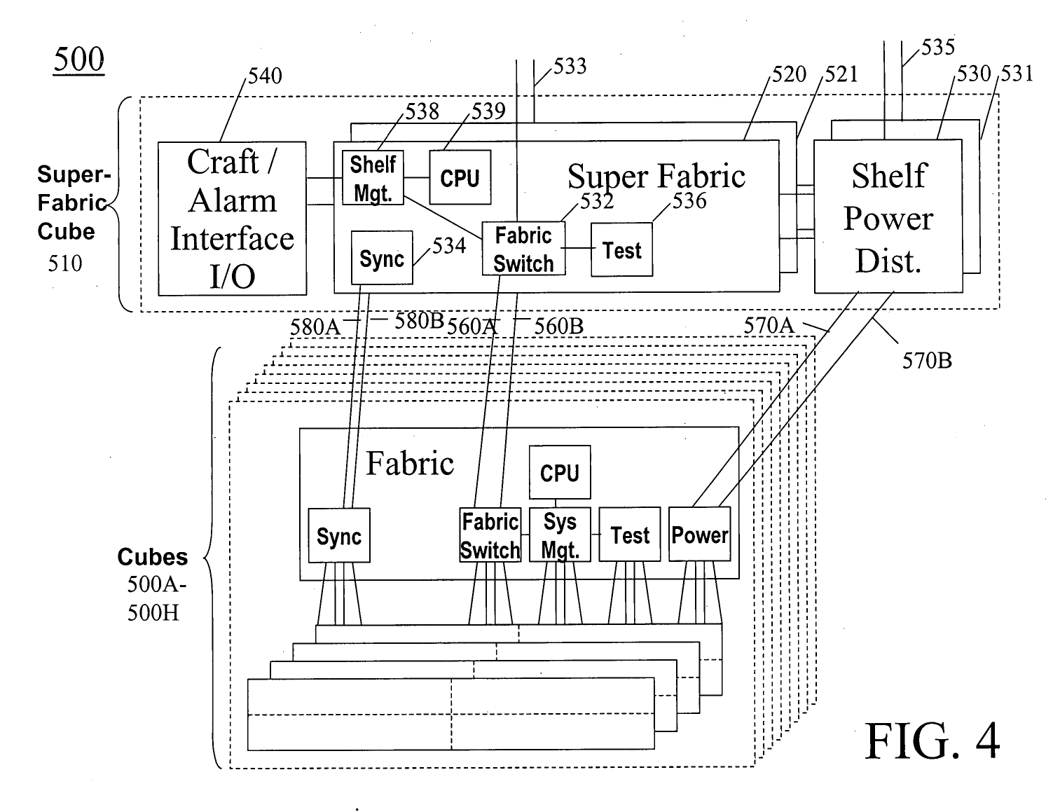

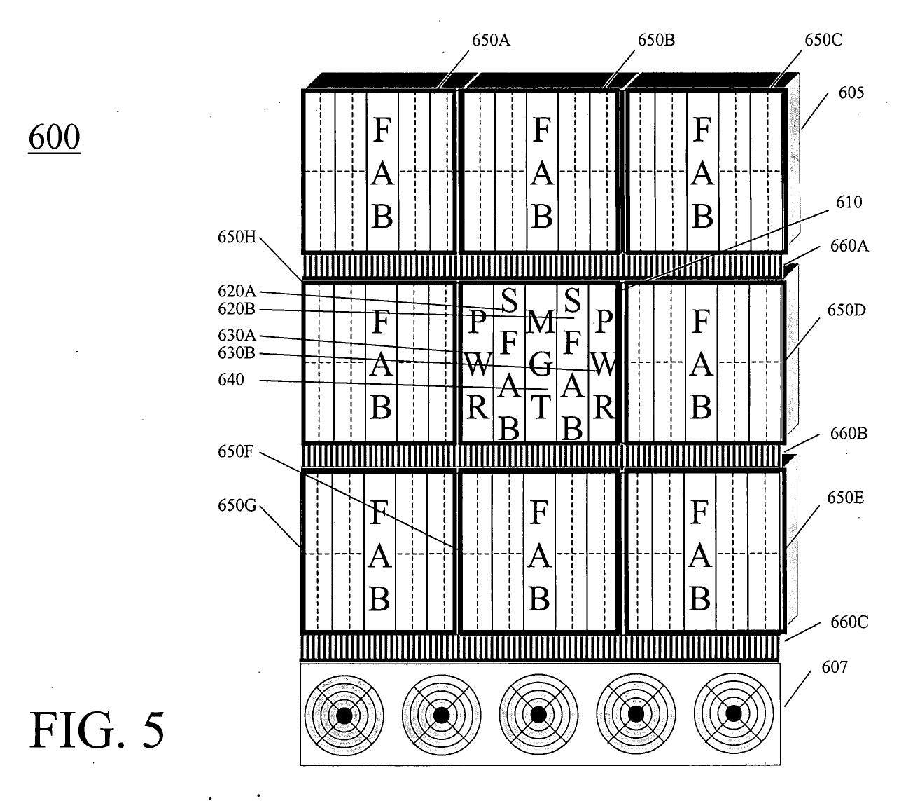

Cube 300 can be used for small scale systems in a standalone mode, or can be interconnected with other cubes to create shelf level systems as shown in the block diagram of FIG. 4 or the mechanical concept of FIG. 5.

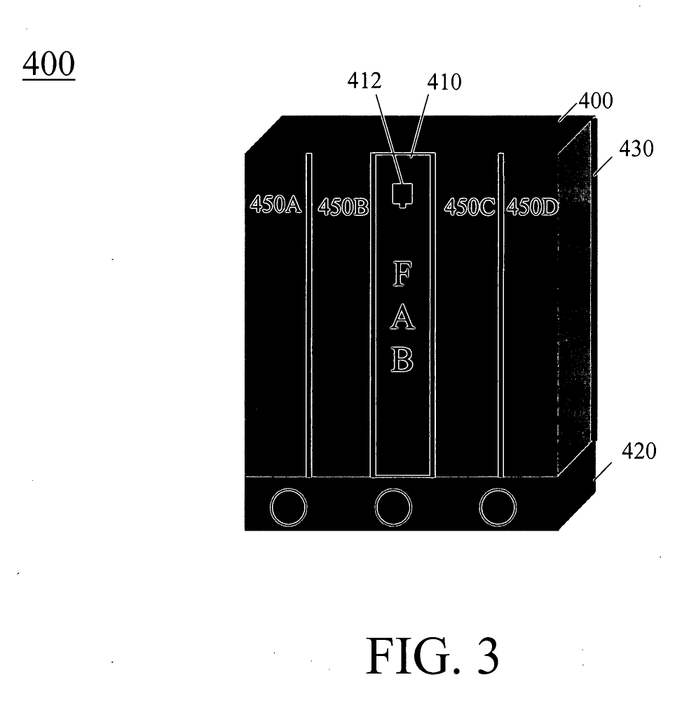

FIG. 3 depicts a mechanical design 400 of a cube 300. Mechanical design 400 provides rigid support for all elements. Backplane 430 interconnects the various elements, and includes conductors for links 332, 336, 338, 340, and 342.

Cooling system 420 provides a means of cooling the electronics within mechanical enclosure 400. Circuit board 410 is the physical embodiment of central resources 310 and includes connectors 412 to accept interconnecting cables leading to higher order system functions. Module circuit boards 450A-450D are the physical implementations of the functions of modules 350A-350D.

FIG. 4 depicts a shelf level system 500 comprising a plurality of cubes 500A-500H and a central SuperFabric cube 510 to interconnect them together. SuperFabric cube 510 includes interconnect and control boards 520 and 521 and shelf level power distributions 530 and 531. Interconnect and control boards 520 and 521 comprise central switching fabric 532, shelf level synchronization circuit 534, shelf test circuit 536, shelf management circuit 538, and shelf control processor 539.

In an exemplary embodiment, at the shelf level, redundancy is often desired. In this exemplary embodiment, SuperFabric cube 510 comprises redundant interconnect and control boards 521 and redundant power distribution board 531.

Interface panel 540 provides shelf level interfaces for alarms and craft control. Cubes 550A through 550H are preferably interconnected with interconnect and control boards 520, 521 and power distribution boards 530 and 531 via communications links 560A, redundant communication links 560B, power links 570A, redundant power links 570B, sync links 580A and redundant sync links 580B. In this manner, superfabric 510 can support, control, and manage a plurality of cubes in its domain. Uplinks 533 and power connections 535 connect the shelf level system to higher level infrastructure.

FIG. 5 shows the mechanical design of shelf level system 600, which is depicted in the block diagram shown in FIG. 4. Shelf level system 600 comprises mechanical support elements 605, shelf level cooling elements 607, a Superfabric cube 610, and a plurality of cube packages 650A-650H.

Superfabric cube 610 includes the elements shown in 510 in FIG. 4, namely a pair of interconnect and control boards 620A and 620B, a pair of shelf level power distribution boards 630A and 630B, and a craft and alarm interface panel 640. Advantageously, the superfabric mechanical packaging shown in superfabric cube 610 preferably has the same footprint and mechanical interfaces as cube mechanical enclosure 400, so it is possible to configure different numbers of cubes and superfabrics in shelf 600, depending upon the needs of the particular application. Also shown are shelf level cable management devices 660A-660C.

Interconnection among the elements depicted in FIG. 5 are preferably via front panel cables. Alternately, interconnection is accomplished via a second order backplane that is located behind the cubes.

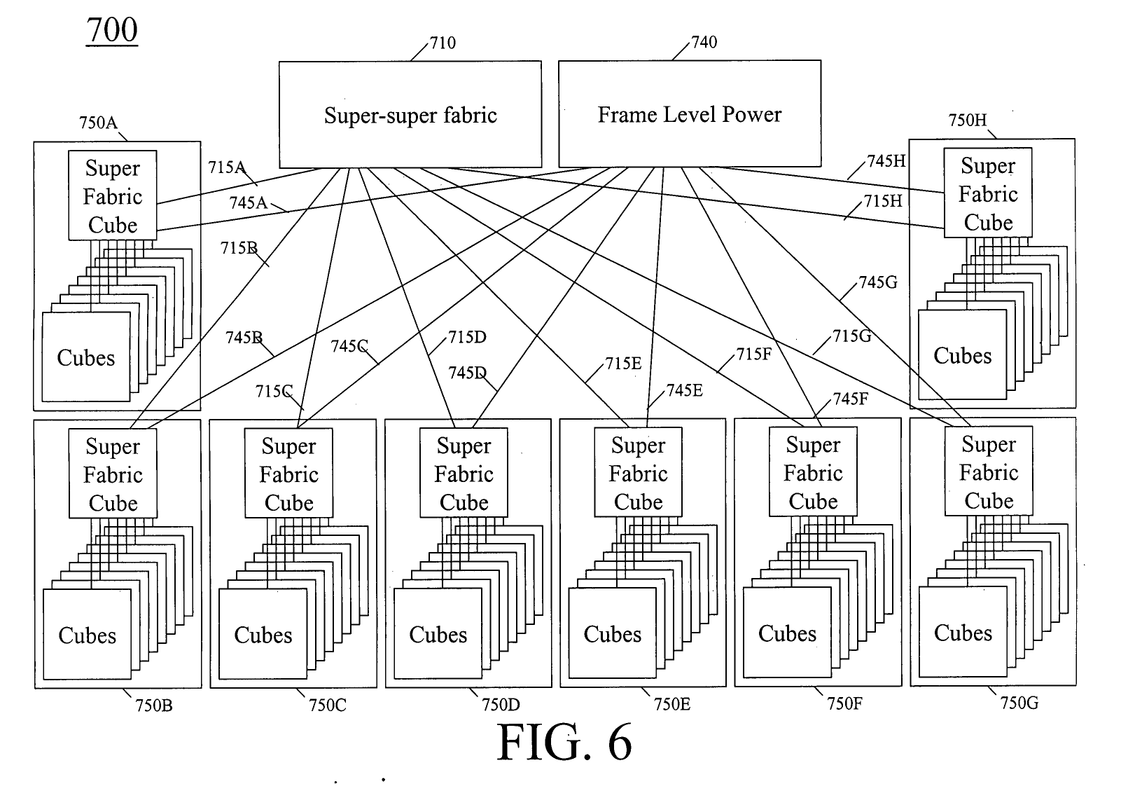

FIG. 6 depicts a block diagram of a multi-shelf system 700. Multi-shelf system 700 includes a number of shelf level systems 750A-750H, a super-superfabric 710 to interconnect shelf level systems 750A-750H, and a frame level power infrastructure 740. Shelves are interconnected with the super-superfabric with inter-shelf interconnect facilities 715A-H and frame level power wiring 745A-H. In the preferred embodiment, up to eight shelves of cubes are interconnected with a single super-superfabric shelf. Also in the preferred embodiment, the super-superfabric shelf is an Advanced TCA system.

It should be understood that cubes need not comprise modules and fabrics, but may comprise larger scale package modules. As examples, these can include but are not limited to optical amplifiers, disk arrays, radio modules, or any other component not amenable to mezzanine module packaging.

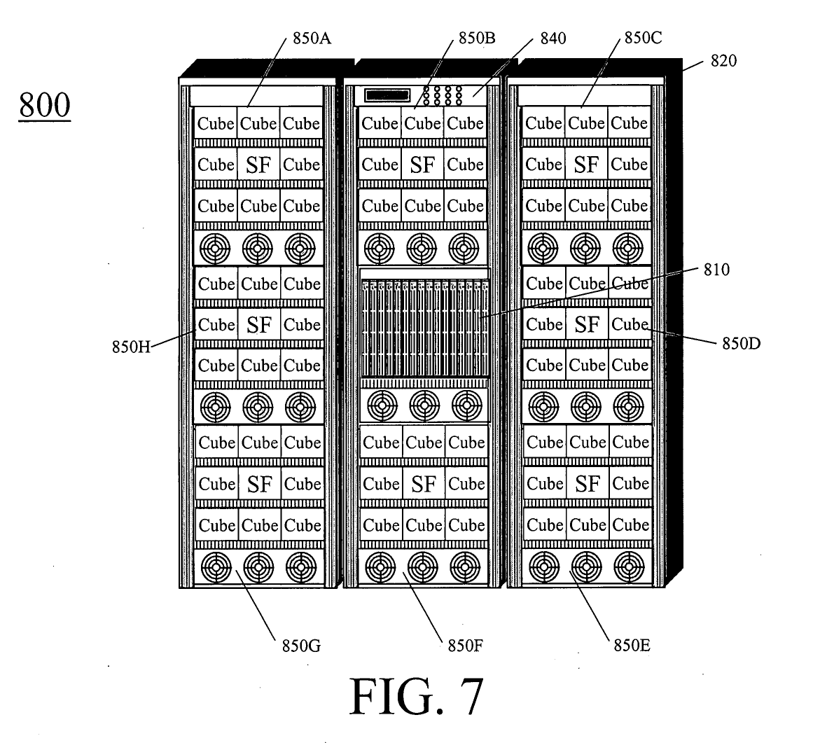

FIG. 7 is a mechanical view 800 of the multi-shelf system 700. Super-superfabric shelf 810 is located in the center of the mechanical arrangement 800. Hierarchical shelves 850A-850H surround the super-superfabric. In the embodiment depicted in FIG. 7, shelves 850A-850H comprise a plurality of shelves, each of which comprises a plurality of eight cubes, as well as a superfabric cube each. Frame level mechanical elements 820 support the shelves. 820 is depicted as three equipment frames, with three shelves per frame. System power elements 840 manage the power distribution across the shelves.

The present invention thereby provides a hierarchical packaging system that permits the construction of a very regular arrangement of electronic components. Systems of very small scale, such as a few modules, as well as very large scale, having thousands of modules, and spanning multiple cabinets, are all easily constructed out of a small number of electrical and mechanical building blocks. The systems of the present invention are efficient to construct and manage, because of the great commonality of elements at all levels, and the regular, hierarchical method of interconnecting, powering, testing and managing them.

While this invention has been described in terms of certain examples thereof, it is not intended that it be limited to the above description, but rather only to the extent set forth in the claims that follow.

I claim:

1. A hierarchical packaging of electronic equipment comprising:
a first order assembly including a plurality of modules and a means of mechanically supporting, interconnecting, powering, cooling and managing said modules; and
a second order assembly comprising a plurality of said first order assemblies, and a means of mechanically supporting, interconnecting, powering, cooling and managing said first order assemblies.

2. A hierarchical packaging of electronic equipment in accordance with claim 1, further comprising a third order assembly comprising a plurality of second order assemblies and a means of interconnecting, powering, cooling and managing said second order assemblies.

3. A hierarchical packaging of electronic equipment in accordance with claim 2, further comprising a fourth assembly comprising a plurality of third order assemblies and a means of interconnecting, powering, cooling and managing said third order assemblies.

4. A hierarchical packaging of electronic equipment in accordance with claim 3, wherein the means of interconnecting and managing the third order assemblies comprises an Advanced TCA shelf.

5. A hierarchical packaging of electronic equipment in accordance with claim 1, wherein the plurality of modules comprise AMC (advanced mezzanine card) mezzanine cards.

6. A hierarchical packaging of electronic equipment in accordance with claim 1, wherein the hierarchical packaging of electronic equipment is approximately cubic in shape.

7. A hierarchical packaging of electronic equipment in accordance with claim 1, wherein the first order assembly is approximately cubic in shape.

8. A hierarchical packaging of electronic equipment in accordance with claim 1, wherein the second order assembly is approximately cubic in shape.

9. A hierarchical packaging of electronic equipment in accordance with claim 1, wherein the second order assembly comprises a two dimensional array of the first order assemblies.

10. A hierarchical packaging of electronic equipment in accordance with claim 9, wherein the two dimensional array fits in a standard equipment rack.

11. A hierarchical packaging of electronic equipment in accordance with claim 1, wherein the means of interconnecting comprises an Ethernet network.

12. A hierarchical packaging of electronic equipment in accordance with claim 1, wherein the means of interconnecting comprises a RapidIO network.

13. A hierarchical packaging of electronic equipment in accordance with claim 1, wherein the means of interconnecting comprises a PCI Express/Advanced Switching network.

14. A hierarchical packaging of electronic equipment in accordance with claim 1, wherein the means of interconnecting comprises an InfiniBand network.

15. A hierarchical packaging of electronic equipment in accordance with claim 1, wherein the means of managing comprises an Intelligent Platform Management Interface (IPMI) infrastructure.

16. A hierarchical packaging of electronic equipment in accordance with claim 1, wherein the first order assembly further comprises a large scale package module.

17. A hierarchical packaging of electronic equipment in accordance with claim 1, wherein the second order assembly further comprises a large scale package module.

18. A hierarchical packaging of electronic equipment in accordance with claim 1, further comprising an interconnect linking the first order assembly and the second order assembly.

19. A hierarchical packaging of electronic equipment in accordance with claim 18, wherein the interconnect comprises a cable.

20. A hierarchical packaging of electronic equipment in accordance with claim 18, wherein the interconnect comprises a backplane.
